(19) United States
(12) Patent Application Publication
(10) Pub. No.: US 2023/0187619 A1
(43) Pub. Date: Jun. 15, 2023

(54) ELECTRODE BODY, RECHARGEABLE BATTERY, AND METHOD FOR MANUFACTURING ELECTRODE BODY

(71) Applicants: PRIMEARTH EV ENRGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Tetsuya KANEKO, Toyohashi-shi (JP); Kazutaka YOSHIKAWA, Hamamatsu-shi (JP); Yoshinori KUDO, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/076,089

(22) Filed: Dec. 6, 2022

(30) Foreign Application Priority Data
Dec. 9, 2021 (JP) 2021-200221

(51) Int. Cl. H01M 4/36; H01M 50/586; H01M 50/59; H01M 4/139; H01M 4/66; H01M 4/62; H01M 4/04

(52) U.S. Cl. CPC H01M 4/366; H01M 50/586; H01M 50/59; H01M 4/139; H01M 4/667; H01M 4/62; H01M 4/0404; H01M 2004/028

(57) ABSTRACT

An electrode body includes a substrate serving as a collector, a composite layer formed by applying a composite paste including an electrode active material to the substrate, and an insulation layer formed by applying an insulation paste including an insulative material to the substrate adjacent to the composite layer. The composite layer extends above and overlaps the insulation layer that covers a surface of the substrate in an interface region of the composite layer and the insulation layer. A mixed layer is formed between the insulation layer and the composite layer when the composite paste and the insulation paste mix in an overlapping range of the insulation layer and the composite layer. The mixed layer is formed in a range where the insulation layer covers the surface of the substrate.

### BACKGROUND

### 1. Field

The present disclosure relates to an electrode body, a rechargeable battery, and a method for manufacturing an electrode body.

### 2. Description of Related Art

A rechargeable battery includes an electrode body having an electrode active material layer formed on a collector. Japanese Laid-Open Patent Publication No. 2021-44162 describes an example of a non-aqueous electrolyte rechargeable battery in which a composite paste including an electrode active material is applied to a substrate that serves as a collector. The composite paste is dried to form a composite layer that serves as an electrode active material layer.

In this example, the substrate has an end that is uncoated. This uncoated portion is connected to an electrode portion. The non-aqueous electrolyte rechargeable battery includes an insulation layer formed on the collector adjacent to the composite layer. The insulation layer is formed by applying an insulation paste that includes an insulative material to the substrate. The insulation paste and the composite paste are simultaneously applied to the substrate. As a result, the composite paste and the insulation paste mix form a mixed layer in an interface region between the composite layer and the insulation layer.

### SUMMARY

When the composite paste applied to the substrate moves in the interface region located at the edge of the composite layer, the composite layer has a tendency of being decreased in thickness. In such a thinned portion, the composite layer will dry quickly. This will easily result in variations produced in the distribution of the binder included in the composite paste. That is, variations will be produced in the distribution of binding components in the dried composite layer. As a result, the binding strength of the composite layer may be reduced.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present disclosure is an electrode body including a substrate serving as a collector, a composite layer formed by applying a composite paste including an electrode active material to the substrate, and an insulation layer formed by applying an insulation paste including an insulative material to the substrate adjacent to the composite layer. The composite layer extends above and overlaps the insulation layer that covers a surface of the substrate in an interface region of the composite layer and the insulation layer. A mixed layer is formed between the insulation layer and the composite layer when the composite paste and the insulation paste mix in an overlapping range of the insulation layer and the composite layer. The mixed layer is formed in a range where the insulation layer covers the surface of the substrate.

In the electrode body, the mixed layer is formed between the insulation layer and a distal end portion of the composite layer extending into the interface region.

In the electrode body, the mixed layer may extend to a position above the insulation layer where the composite layer does not exist.

In the electrode body, the composite layer extending in the interface region may include a composite slope having a thickness that gradually decreases toward an end of the substrate where the insulation layer is applied, the insulation layer may cover the surface of the substrate in a range where the composite slope portion is formed, and the insulation layer does not have to extend beyond a range where the composite slope is formed into an area below the composite layer.

In the electrode body, the insulation layer may have a higher binder component content ratio than the composite paste.

In the electrode body, the composite layer may be a positive electrode active material layer.

A further aspect of the present disclosure is a rechargeable battery including the body electrode described above.

Another aspect of the present disclosure is a method for manufacturing an electrode body including a substrate serving as a collector, a composite layer formed by applying a composite paste including an electrode active material to the substrate, and an insulation layer formed by applying an insulation paste including an insulative material to the substrate adjacent to the composite layer. The method includes simultaneously applying, to the substrate, the composite paste and the insulation paste that are adjusted so that a mixed layer is formed between the insulation layer and the composite layer by mixing the composite paste and the insulation paste in an overlapping range of the insulation layer and the composition layer where the composition layer overlaps an upper side of the insulation layer that covers a surface of the substrate in an interface region of the composite layer and the insulation layer and so that the mixed layer is formed in a range where the insulation layer covers the surface of the substrate.

In the method, the composite layer applied per unit area to the substrate may be greater in amount than the insulation paste.

In the method, the insulation paste may have a lower viscosity in a low shear rate region than the composite paste.

In the method, the insulative material included in the insulation paste may have a smaller particle diameter than the electrode active material included in the composite paste.

In the method, the composite paste applied per unit area to the substrate may be greater in amount than the insulation paste.

In the method, the insulation layer has a higher binder content ratio than the composite paste.

Other features and aspects will be apparent from the following detailed description, the drawings, and the claims.

### BRIEF DESCRIPTION OF THE DRAWINGS

FIG. 1 is a perspective view of a rechargeable battery.

FIG. 2 is an exploded view of an electrode body.

FIG. 3 is a side view of the rechargeable battery.

FIG. 4 is a cross-sectional view showing a stack structure of a composite layer, an insulation layer, and a mixed layer.

FIG. 5 is a flowchart illustrating a method for manufacturing the electrode body.

FIG. 6 is a diagram illustrating adjustment of a composite paste and an insulation paste.

FIG. 7 is a cross-sectional view showing a stack structure of a comparative example.

FIG. 8 is a cross-sectional view showing a stack structure of a comparative example.

FIG. 9 is a cross-sectional view showing a stack structure of a comparative example.

FIG. 10 is a cross-sectional view showing a stack structure of a further example.

FIG. 11 is a cross-sectional view showing a stack structure of another example.

FIG. 12 is a cross-sectional view showing a stack structure of a comparative example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art

One embodiment of a rechargeable battery and an electrode will now be described with reference to the drawings.

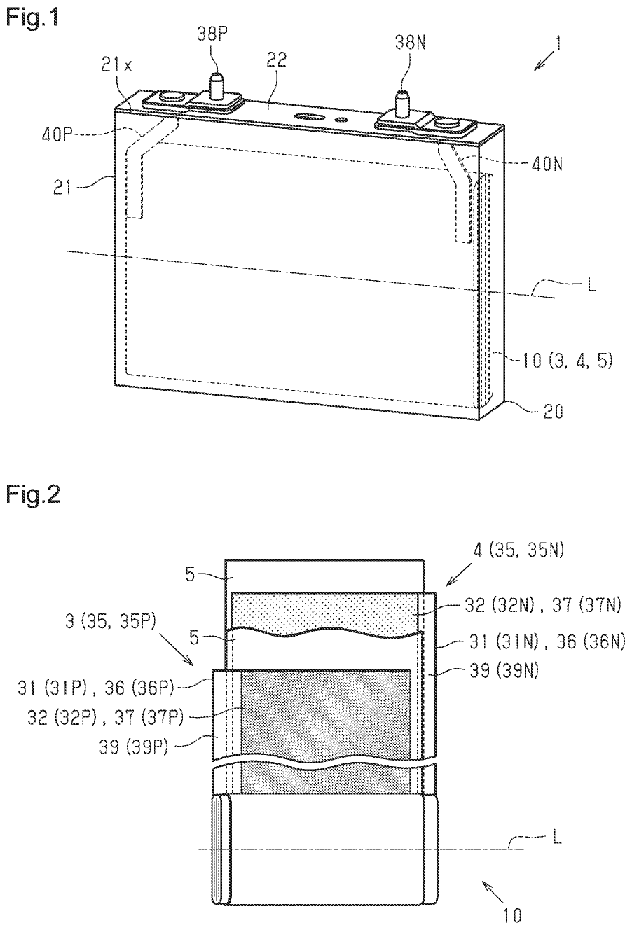

As shown in FIG. 1, a rechargeable battery 1 includes an electrode body 10 and a case 20. The electrode body 10 integrates a positive electrode 3, a negative electrode 4, and a separator 5. The case 20 accommodates the electrode body 10. The rechargeable battery 1 of the present embodiment forms a lithium-ion battery in which the electrode body 10 is immersed in an non-aqueous electrolyte inside the case 20.

In the rechargeable battery 1 of the present embodiment, sheets of the positive electrode 3, the negative electrode 4, and the separator 5 are arranged in a stack. The stack of the positive electrode 3, the negative electrode 4, and the separator 5 are rolled with the separator 5 held between the positive electrode 3 and the negative electrode 4 to form the electrode body 10 in which the positive and negative electrodes and the separator 5 are alternately arranged in the radial direction.

The case 20 of the present embodiment includes a box-shaped case body 21 and a lid 22 that closes an open end 21x of the case body 21. The electrode body 10 of the present embodiment is shaped in correspondence with the box-shaped case 20.

As shown in FIG. 2, in the rechargeable battery 1 of the present embodiment, the positive electrode 3 and the negative electrode 4 each have the form of an electrode sheet 35 that includes a sheet of a collector 31 and an electrode active material layer 32 applied to the collector 31.

In the electrode sheet 35P for the positive electrode 3, a composite paste 37P, which includes lithium transition metal oxide serving as a positive electrode active material, is applied to a substrate 36P, which is formed from aluminum or the like and serves as a positive electrode collector 31P. In the electrode sheet 35N for the negative electrode 4, a composite paste 37N, which includes a carbon material serving as a negative electrode active material, is applied to a substrate 36N, which is formed from copper or the like and serves as a negative electrode collector 31N. The composite pastes 37P and 37N each include a binder. In the rechargeable battery 1 of the present embodiment, the composite pastes 37P and 37N are dried to form a positive electrode active material layer 32P and a negative electrode active material layer 32N on the positive and negative electrode sheets 35P and 35N, respectively.

In the rechargeable battery 1 of the present embodiment, the positive and negative electrode sheets 35P and 35N are shaped into strips. Further, in the electrode body 10 of the present embodiment, the stack of the positive and negative electrode sheets 35P and 35N with the separator 5 held in between is rolled about a rolling axis L extending in the widthwise direction of the strips (lateral direction in FIG. 2).

In FIG. 2, the separator 5 and the electrode sheets 35 are rolled with the electrode sheet 35P, which forms the positive electrode 3, arranged at the inner side. The drawings shows one example of the structure of the electrode body 10, and the separator 5 and the electrode sheets 35 may be rolled with the electrode sheet 35N, which forms the negative electrode 4, located at the inner side. This determines whether the electrode sheet 35 arranged at the outermost part of the electrode body 10 is the electrode sheet 35P forming the positive electrode 3 or the electrode sheet 35N forming the negative electrode 4.

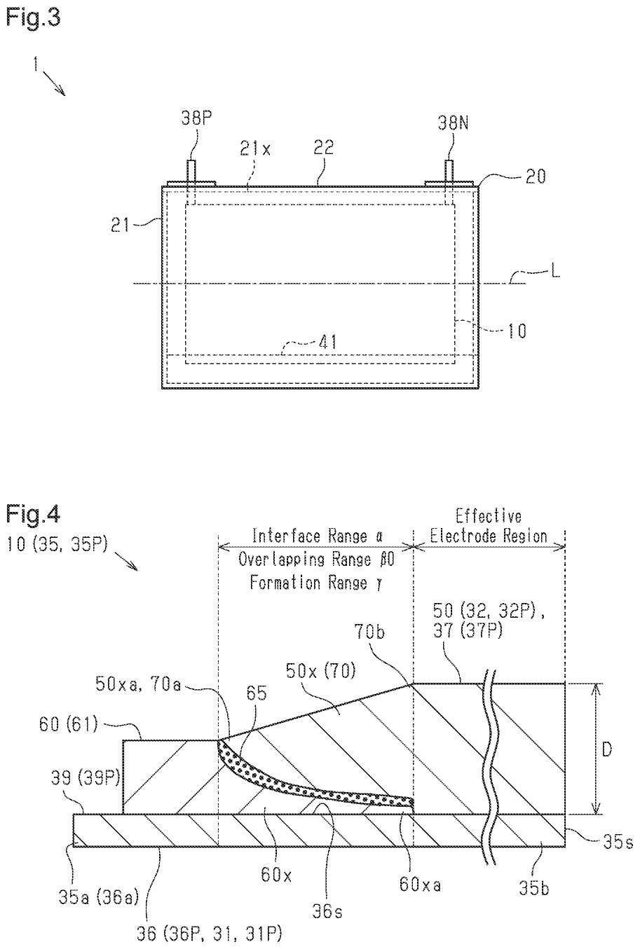

As shown in FIGS. 1 to 3, the lid 22 of the case 20 includes a positive electrode terminal 38P and a negative electrode terminal 38N that project outward from the case 20. Further, the collector 31 of each electrode sheet 35 includes an uncoated portion 39 where the electrode active material layer 32 is not applied. In the rechargeable battery 1 of the present embodiment, these uncoated portions 39 are used to connect the electrode sheet 35P, which forms the positive electrode 3, to the positive electrode terminal 38P and connect the electrode sheet 35N, which forms the negative electrode 4, to the negative electrode terminal 38N.

More specifically, the electrode body 10 of the present embodiment is accommodated in the case 20 so that its rolling axis L extends in the longitudinal direction of the rectangular lid 22 (lateral direction in FIG. 1). Further, in this state, the uncoated portion 39P of the electrode sheet 35P, which forms the positive electrode 3, is connected to the positive electrode terminal 38P by a connecting member 40P. In the same manner, the uncoated portion 39N of the electrode sheet 35N, which forms the negative electrode 4, is connected to the negative electrode terminal 38N by a connecting member 40N.

The case 20 is filled with an electrolyte solution 41. In the electrolyte solution 41 of the rechargeable battery 1, which serves as a lithium-ion battery, lithium salt, which serves as support salt, is dissolved in an organic solvent. In the rechargeable battery 1 of the present embodiment, the electrode body 10, which is enclosed in the case 20, is immersed in the electrolyte solution 41.

Composite Layer, Insulation layer, and Mixed Layer

The electrode body 10 forming the rechargeable battery 1 of the present embodiment, more specifically, the stack of the composite layer, the insulation layer, and the mixed layer on the substrate of the electrode sheet 35 will now be described.

As shown in FIG. 4, in the rechargeable battery 1 of the present embodiment, the electrode active material layer 32 of the electrode sheet 35 in the electrode body 10 is formed by a composite layer 50 obtained by applying a composite paste 37 including an electrode active material to a substrate 36 that serves as the collector 31.

More specifically, the electrode sheet 35 shown in FIG. 4 is the electrode sheet 35P for the positive electrode 3 including the positive electrode active material layer 32P formed on the substrate 36P that serves as the positive electrode collector 31P. Further, the electrode sheet 35 includes an insulation layer 60 applied to the substrate 36 adjacent to the composite layer 50. The insulation layer 60 partially covers the uncoated portion 39 set in a first end 35a of the electrode sheet 35, which is a strip of foil. In the electrode sheet 35 of the present embodiment, the second end 35b of the insulation layer 60 opposite the first end 35a includes a cut surface 35s where the substrate 36 and the composite layer 50 are integrally cut to shape the electrode sheet 35 into a strip. In the rechargeable battery 1 of the present embodiment, the insulation layer 60 is formed by applying an insulation paste 61 that includes an insulative material to the substrate 36.

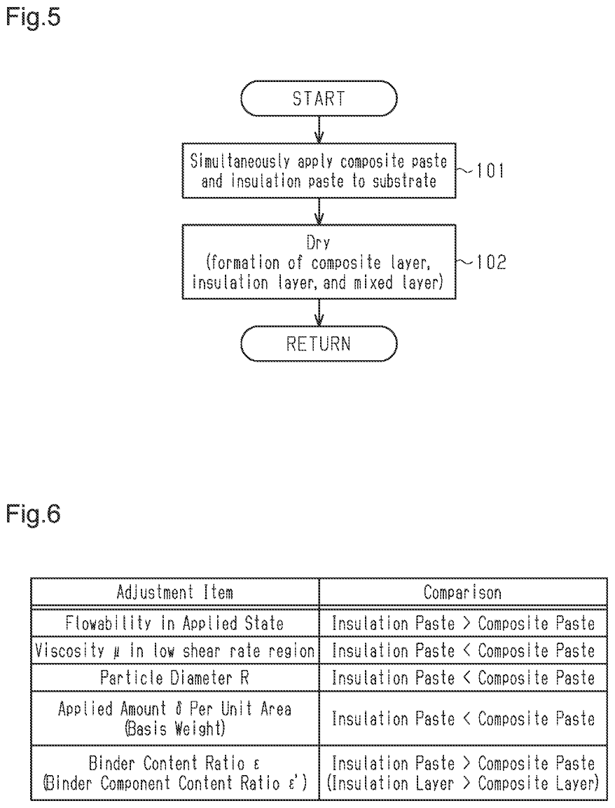

More specifically, as shown in FIG. 5, in the rechargeable battery 1 of the present embodiment, the composite paste 37 and the insulation paste 61 are simultaneously applied to the substrate 36 (step 101). The composite paste 37 and the insulation paste 61 are applied spaced apart by a slight gap. Then, the composite paste 37 and the insulation paste 61 are dried to form the composite layer 50 and the insulation layer 60 that are adjacent to each other on the substrate 36 (step 102).

Further, as shown in FIG. 4, the electrode sheet 35 of the present embodiment includes a mixed layer 65 where the composite paste 37 and the insulation paste 61 applied to the substrate 36 mix in an interface region α of the composite layer 50 and the insulation layer 60. Movement of the composite paste 37 and the insulation paste 61 applied to the substrate 36 forms the interface region α of the composite layer 50 and the insulation layer 60. In the electrode sheet 35 of the present embodiment, the mixed layer 65 is formed in an overlapping range β0 of a composite layer 50x and an insulation layer 60x that extend in the interface region α.

More specifically, in the interface region α of the composite layer 50 and the insulation layer 60, the insulation layer 60x that extends in the interface region α covers the surface 36s of the substrate 36, and the composite layer 50x extends above the insulation layer 60x in an overlapping manner. The electrode sheet 35 of the present embodiment includes the mixed layer 65, which is formed between the composite layer 50x and the insulation layer 60x, in the overlapping range β0 of the composite layer 50x and the insulation layer 60x.

In the mixed layer 65, for example, the contained amount of insulative material is 30% to 70% of the average concentration of the insulation layer 60, and the contained amount of electrode active material is 30% to 70% of the average concentration of the composite layer 50. The numerical values indicated here represent the lower limit value and the upper limit value of a range. The same applies to the description hereafter.

In the electrode sheet 35 of the present embodiment, the mixed layer 65 is formed in a range where the insulation layer 60x covers the surface 36s of the substrate 36. More specifically, the mixed layer 65 extends over the entire overlapping range β0 of the composite layer 50x and the insulation layer 60x. The electrode sheet 35 of the present embodiment includes the mixed layer 65 that extends between the composite layer 50x and the insulation layer 60x over substantially the entire interface region α.

In the electrode sheet 35 of the present embodiment, the composite layer 50x extending in the interface region α includes a composite slope 70 having a thickness D that gradually decreases toward an end 36a of the substrate 36 where the insulation layer 60 is applied (left side in FIG. 4). Further, in the formation range γ of the composite slope 70, the insulation layer 60x covers the surface 36s of the substrate 36. Moreover, in the electrode sheet 35 of the present embodiment, the insulation layer 60x does not extend beyond the formation range γ of the composite slope 70 into an area below the composite layer 50x.

In the electrode sheet 35 of the present embodiment, the composite layer 50 has a greater thickness D than the insulation layer 60 on the substrate 36. Thus, the composite paste 37 applied to the substrate 36 moves toward the end 36a of the substrate 36 where the insulation layer 60 is formed. This forms the composite slope 70 in the interface region α at the edge of the composite layer 50.

The insulation layer 60x is not formed beyond the range of the composite slope 70 and thus does not enter a range where movement of the composite paste 37 subtly affects the thickness. Thus, the composite layer 50 has sufficient thickness D and entirely functions as an effective electrode region outside the range where the composite slope 70 is formed. This improves the performance of the rechargeable battery 1 in the present embodiment.

Process for Forming Composite Layer, Insulation Layer, and Mixed Layer

In the method for manufacturing the electrode body 10 of the present embodiment, the process for forming the stack structure of the composite layer 50, the insulation layer 60, and the mixed layer 65 will now be described.

As shown in FIG. 6, in the rechargeable battery 1 of the present embodiment, the composite paste 37 and the insulation paste 61 applied to the substrate 36 are adjusted to form the stack structure of the composite layer 50, the insulation layer 60, and the mixed layer 65 in the interface region α.

When applying the composite paste 37 and the insulation paste 61 to the substrate 36, the insulation paste 61 has a higher flowability than the composite paste 37 in a state applied to the substrate 36. As a result, in the interface region α of the composite layer 50 and the insulation layer 60, the insulation paste 61 applied to the substrate 36 moves into an area below the composite paste 37.

The insulation paste 61 has a lower viscosity μ, which is a physical property value, in a low shear rate region than the composite paste 37. Further, the composite paste 37 and the insulation paste 61 are adjusted so that the insulative material included in the insulation paste 61 has a smaller particle diameter R than the electrode active material included in the composite paste 37.

The applied amount δ per unit area of the composite paste 37 to the substrate 36 is greater than that of the insulation paste 61. Here, the applied amount per unit area refers to, for example, the basis weight. Preferably, the basis weight is adjusted so that the ratio of the insulation paste 61 to the composite paste 37 is in the range of 1:2 to 1:5.

Further, the insulation paste 61 has a higher binder content ratio ε than the composite paste 37. The value of the content ratio ε may be set so that, for example, the content ratio ε in the insulation paste 61 is 2.5 wt % or greater, and the content ratio ε in the composite paste 37 is 0.1 wt % to 1.0 wt %. Here, wt % refers to percent by weight. When the composite paste 37 and the insulation paste 61 are dried, the binder content ratio ε in the composite paste 37 and the insulation paste 61 changes to binder content ratio e. This increases the binding strength of the insulation layer 60 in the electrode sheet 35 of the present embodiment.

Operation

The operation of the electrode sheet 35 including the stack structure of the composite layer 50, the insulation layer 60, and the mixed layer 65 will now be described.

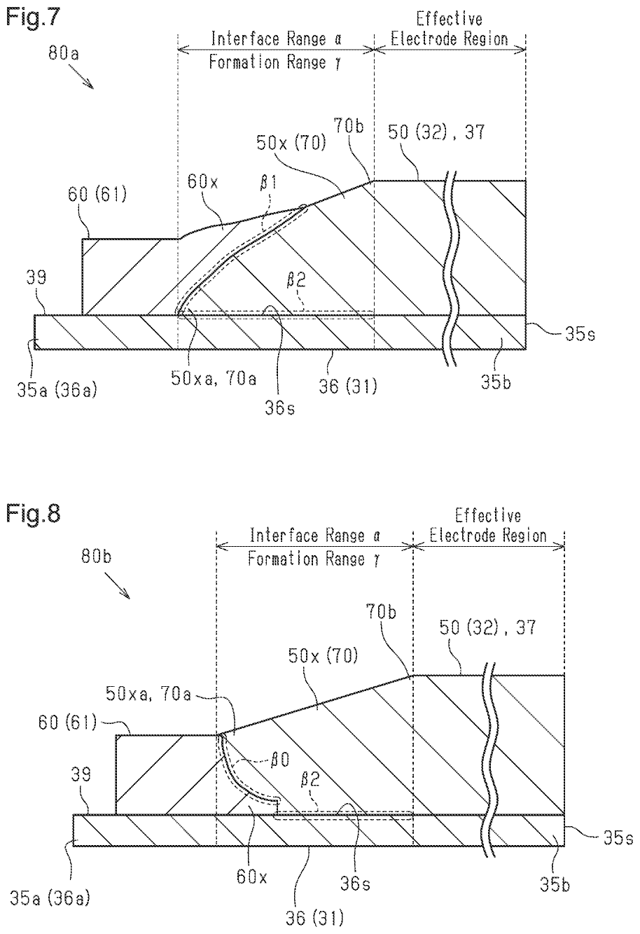

FIGS. 7 to 9 show electrode sheets 80a to 80c of comparative examples, each of which does not include the mixed layer 65 in the interface region α of the composite layer 50 and the insulation layer 60. In this respect, the binding strength of the composite layer 50x extending in the interface region α in the electrode sheet 35 of the present embodiment is greater than that in the electrode sheets 80a to 80c of the comparative examples.

More specifically, movement of the composite paste 37 applied to the substrate 36 forms a composite layer 50x that extends into the interface region α with the insulation layer 60. The thickness D of the composite slope 70 formed in the composite layer 50x gradually decreases from a proximal end 70b toward a distal end 70a. This results in the tendency of variations being produced in the distribution of the binder included in the composite paste 37 in the formation range γ of the composite slope 70 when the composite paste 37 is dried. Further, it is difficult to increase the binder content ratio ε since the content ratio of the electrode active material in the composite paste 37 will directly affect the battery performance Thus, in the electrode sheets 80a to 80c of the comparative example, the binding strength will easily decrease in the composite layer 50x extending in the interface region α.

Particularly, in the electrode sheet 80a shown in FIG. 7, the insulation layer 60x extends into the interface region α overlapping, from above, the composite layer 50x that covers the surface 36s of the substrate 36. Thus, in the electrode sheet 80a of the comparative example, the binding strength easily decreases in an overlapping range β1 of the composite layer 50x and the insulation layer 60x and in range β2 where the composite layer 50x covers the surface 36s of the substrate 36.

In this respect, as shown in FIG. 4, in the electrode sheet 35 of the present embodiment, the insulation layer 60x extending in the interface region α covers substantially the entire surface 36s of the substrate 36 in the formation range γ of the composite slope 70. The insulation layer 60 only needs to include an amount of insulative material that obtains the insulative characteristic of the insulation paste 61. This allows the binding strength to be increased by increasing the binder content ratio. Further, in the electrode sheet 35 of the present embodiment, the insulation layer 60 covering the surface 36s of the substrate 36 strongly binds with the substrate 36.

The mixed layer 65 formed in the overlapping range β0 of the composite layer 50x and the insulation layer 60x is easily integrated with the insulation layer 60x, which is located thereunder, and the composite layer 50x, which is located thereover. In the electrode sheet 35 of the present embodiment, the mixed layer 65 strongly binds the insulation layer 60x, which is located thereunder, and the composite layer 50x, which is located thereover.

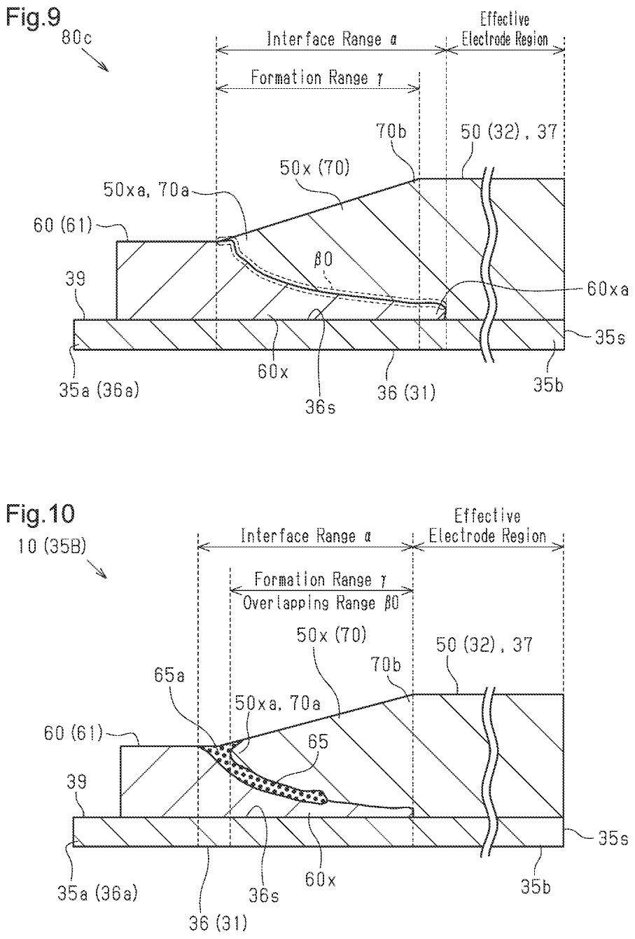

In the electrode sheets 80b and 80c shown in FIGS. 8 and 9, the composite layer 50x extends above and overlaps the insulation layer 60x, which covers the surface 36s of the substrate 36, in the interface region α of the composite layer 50x and the insulation layer 60x. The electrode sheets 80b and 80c, however, do not include the mixed layer 65 in the overlapping range β0 of the composite layer 50x and the insulation layer 60x. Thus, in the electrode sheets 80b and 80c, the binding strength also easily decreases in the overlapping range β0 of the composite layer 50x and the insulation layer 60x.

Particularly, in the composite layer 50x extending in the interface region α , the composite slope 70 extending from the proximal end 70b to the distal end 70a decreases in thickness D at the distal end portion 50xa. Thus, in the electrode sheets 80b and 80c, the binding strength easily decreases particularly at the distal end portion 50xa of the composite layer 50x.

In this respect, as shown in FIG. 4, in the electrode sheet 35 of the present embodiment, the mixed layer 65 is formed between the distal end portion 50xa of the composite layer 50x and the insulation layer 60x, which is located thereunder. Thus, in the electrode sheet 35 of the present embodiment, a high binding strength is also obtained in the distal end portion 50xa of the composite layer 50x where the thickness D tends to decrease.

In the electrode sheet 80b of the comparative example shown in FIG. 8, the composite layer 50x extending in the interface region α covers the surface 36s of the substrate 36 in range β2. Thus, in the electrode sheet 80b, the bonding strength also easily decreases in range β2 where the composite layer 50x covers the surface 36s of the substrate 36.

In contrast, in the electrode sheet 35 of the present embodiment, the insulation layer 60x covers the surface 36s of the substrate 36 in the formation range γ of the composite slope 70 (refer to FIG. 4), as described above. This obtains a high binding strength for the composite layer 50x extending in the interface region α.

In the electrode sheet 80c shown in FIG. 9, the insulation layer 60x extends beyond the formation range γ of the composite slope 70 into an area below the composite layer 50x. The distal end portion 60xa of the insulation layer 60x enters the range where the composite slope 70 is not formed, which should be used as the electrode region, and covers the surface 36s of the substrate 36 in this range.

In this respect, as shown in FIG. 4, in the electrode sheet 35 of the present embodiment, the insulation layer 60x does not extend beyond the formation range γ of the composite slope 70 into an area below the composite layer 50x. This allows the range where the composite slope 70 is not formed to be effectively used as the electrode region thereby improving the battery performance.

The advantages of the present embodiment will now be described.

(1) Each electrode sheet 35 in the electrode body 10 of the rechargeable battery 1 includes the substrate 36, serving as the collector 31, and the composite layer 50, formed by applying the composite paste 37 including an electrode active material to the substrate 36. Further, the electrode sheet 35 includes the insulation layer 60, which is formed by applying the insulation paste 61 including an insulative material to the substrate 36 adjacent to the composite layer 50. In the interface region α of the composite layer 50 and the insulation layer 60, the composite layer 50x extends above and overlaps the insulation layer 60x that covers the surface 36s of the substrate 36. The electrode sheet 35 also includes the mixed layer 65 formed between the insulation layer 60x and the composite layer 50x when the composite paste 37 and the insulation paste 61 mix in the overlapping range β0 of the insulation layer 60x and the composite layer 50x. The mixed layer 65 is formed in the range in which the insulation layer 60x covers the surface 36s of the substrate 36.

The insulation layer 60x, which acts to increase the binding component content ratio β′, covers the surface 36s of the substrate 36. Thus, the insulation layer 60x, which extends in the interface region α , is strongly bonded to the substrate 36. The mixed layer 65, which acts to integrate the lower insulation layer 60x with the upper composite layer 50x, is formed in the overlapping range β0 of the insulation layer 60x and the composite layer 50x. Thus, the mixed layer 65 strongly binds the insulation layer 60x and the composite layer 50x. This increases the binding strength of the composite layer 50x extending in the interface region α. Further, the mixed layer 65 is formed in the range in which the insulation layer 60 covers the surface 36s of the substrate 36. Thus, the mixed layer 65 does not allow the composite layer 50 to cover the surface 36s of the substrate 36 and stops corrosion of the electrode region. This improves the battery performance.

(2) Each electrode sheet 35 includes the mixed layer 65 formed between the insulation layer 60x and the distal end portion 50xa of the composite layer 50x extending in the interface region α.

Thus, the thickness D of the composite layer 50x extending in the interface region α decreases in the distal end portion 50xa. As a result, the binding strength has a tendency of decreasing in the distal end portion 50xa. With the above structure, however, the mixed layer 65, formed between the insulation layer 60x and the distal end portion 50xa of the composite layer 50x, strongly binds the insulation layer 60x and the distal end portion 50xa of the composite layer 50x. This increases the binding strength of the composite layer 50x extending in the interface region α.

(3) The composite layer 50x extending in the interface region α includes the composite slope 70 that gradually decreases the thickness D toward the end 36a of the substrate 36 where the insulation layer 60 is applied. In the formation range γ of the composite slope 70 of the electrode sheet 35, the insulation layer 60x covers the surface 36s of the substrate 36, and the insulation layer 60x does not extend beyond the formation range γ of the composite slope 70 into an area below the composite layer 50.

With the above structure, although the binding strength would be decreased when thinned, the composite slope 70 has a high binding strength. Further, the insulation layer 60x that covers the surface 36s of the substrate 36 does not enter the range where the composite slope 70 is not formed, that is, the range that should be used as the electrode region. This improves the battery performance.

(4) The composite layer 50 is the positive electrode active material layer 32P. This allows the electrode sheet 35P for the positive electrode 3 to be formed with high quality.

(5) The composite paste 37 and the insulation paste 61 are simultaneously applied to the substrate 36.

With the above structure, movement of the composite paste 37 and the insulation paste 61 applied to the substrate 36 results in mixing of the composite paste 37 and the insulation paste 61 in the interface region α of the composite layer 50 and the insulation layer 60. This forms the stack of the composite layer 50, the insulation layer 60, and the mixed layer 65 with a simple structure in an optimal manner.

(6) When applied to the substrate 36, the insulation paste 61 has a higher flowability than the composite paste 37.

Thus, the insulation paste 61 applied to the substrate 36 easily moves to the lower side of the composite paste 37. This forms the stack structure of the composite layer 50, the insulation layer 60, and the mixed layer 65 in the interface region α in an optimal manner.

(7) The insulation paste 61 has a lower viscosity μ in a low shear rate region than the composite paste 37. This forms the stack structure of the composite layer 50, the insulation layer 60, and the mixed layer 65 in the interface region α in an optimal manner.

(8) The composite paste 37 and the insulation paste 61 are adjusted so that the insulative material included in the insulation paste 61 has a smaller particle diameter R than the electrode active material included in the composite paste 37. This forms the stack structure of the composite layer 50, the insulation layer 60, and the mixed layer 65 in the interface region α in an optimal manner.

(9) The applied amount δ per unit area of the composite paste 37 to the substrate 36 is greater than that of the insulation paste 61. This forms the stack structure of the composite layer 50, the insulation layer 60, and the mixed layer 65 in the interface region α in an optimal manner.

(10) The composite paste 37 has a higher binder content ratio ε than the insulation paste 61.

This increases the binding strength of the composite layer 50x extending in the interface region α while improving the battery performance

The above embodiment may be modified as described below. The above-described embodiment and the modified examples described below may be combined as long as there is no technical contradiction.

In the above embodiment, the mixed layer 65 extends between the composite layer 50x and the insulation layer 60x over the entire overlapping range β0 of the composite layer 50x and the insulation layer 60x. The mixed layer 65, however, does not necessarily have to extend over the entire overlapping range β0 of the composite layer 50x and the insulation layer 60x. In any case, it is preferred that the mixed layer 65 be formed between the insulation layer 60x and the distal end portion 50xa of the composite layer 50x.

FIG. 10 shows an example of an electrode sheet 35B in which the mixed layer 65 extends to a position where the composite layer 50x does not exist above the insulation layer 60x. In the electrode sheet 35B, the distal end 65a of the mixed layer 65, which is exposed upward from the insulation layer 60x extends above the composite layer 50x. In the electrode sheet 35B of this example, the distal end portion 50xa of the composite layer 50x extending in the interface region α further increases the binding strength.

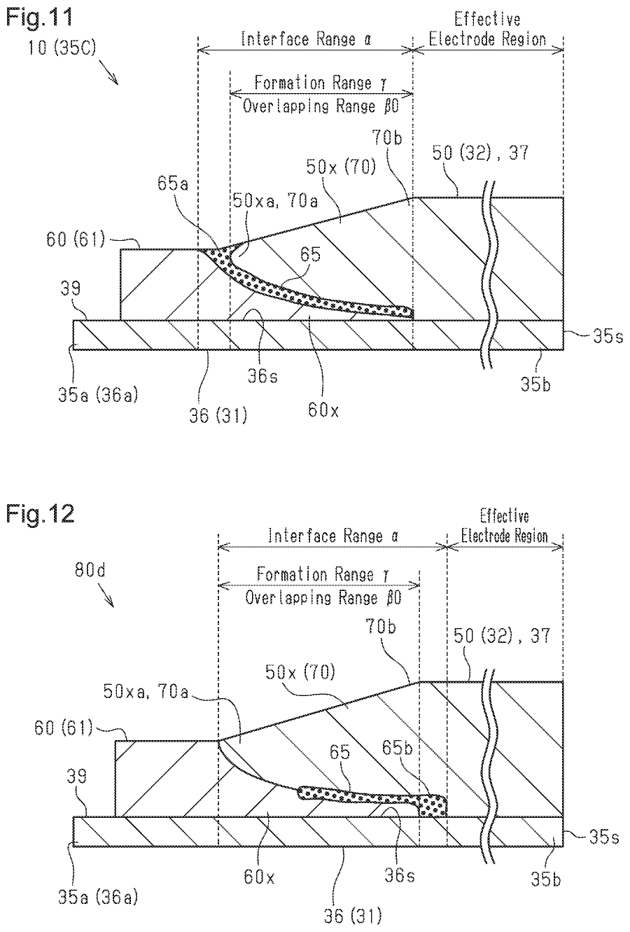

FIG. 11 shows another example of an electrode sheet 35C in which the mixed layer 65 extends over the entire overlapping range β0 of the composite layer 50x and the insulation layer 60x. The mixed layer 65 further extends to a position where the composite layer 50x does not exist above the insulation layer 60x. This further increases the binding strength of the composite layer 50x extending in the interface region α.

In any case, it is preferable that the mixed layer 65 does not extend beyond the formation range γ of the composite slope 70 into an area below the composite layer 50x.

FIG. 12 shows an electrode sheet 80d of a comparative example in which an end 65b of the mixed layer 65 extends beyond the overlapping range β0 of the composite layer 50x and the insulation layer 60x into a range where the composite slope 70 is not formed so as to cover the surface 36s of the substrate 36. This reduces the region that can be effectively used as an electrode. Thus, the battery performance may be adversely affected.

Further, in the electrode sheet 80d of the comparative example, the mixed layer 65 is not formed near the distal end portion 50xa of the composite layer 50x. This may decrease the binding strength of the distal end portion 50xa of the composite layer 50x.

The formation range γ of the composite slope 70 does not necessarily have to extend over the entire interface region α. In the same manner as the electrode sheets 35B and 35C of the examples shown in FIGS. 10 and 11, the composite slope 70 may be formed in part of the interface region α.

The interface region α is a layer formation region on the substrate 36 including an interface or a part where two of the composite layer 50, the insulation layer 60, and the mixed layer 65 contact each other. The portion of layers that are changed by movement of the composite paste 37 and the insulation paste 61 applied to the substrate 36 during formation of the interface is also included in the interface region α in the same manner as the composite slope 70.

In the above embodiment, the composite paste 37 and the insulation paste 61 are simultaneously applied to the substrate 36. In this case, the flowability when applied to the substrate 36, the viscosity μ in a low shear rate region, the particle diameter R, the applied amount δ per unit area, and the binder content ratio ε are adjusted for the composite paste 37 and the insulation paste 61. This forms the stack structure of the composite layer 50, the insulation layer 60, and the mixed layer 65 in the interface region α of the composite layer 50 and the insulation layer 60 in an optimal manner.

There is no limit to the items that are adjusted to form the optimal stack structure of the composite layer 50, the insulation layer 60, and the mixed layer 65. For example, the items listed above may be combined in any manner. At least one of the above adjustment items may be adjusted. An adjustment item that is not listed above may be added.

When applying the composite paste 37 and the insulation paste 61 to the substrate 36 to form the composite layer 50 and the insulation layer 60, the position where the mixed layer 65 is formed may be controlled by adjusting the viscosity difference, the particle diameter, the applying pressure, and the like. When the optimal stack structure such as that described above can be formed, the composite paste 37 and the insulation paste 61 do not have to be simultaneously applied.

The above embodiment exemplifies the electrode sheet 35P for the positive electrode 3 including the positive electrode active material layer 32P applied to the substrate 36P that serves as the positive electrode collector 31P and illustrates the optimal stack structure of the composite layer 50, the insulation layer 60, and the mixed layer 65 that are formed on the substrate 36. The same structure may be applied to the electrode sheet 35N for the negative electrode 4 including the negative electrode active material layer 32N formed on the substrate 36N that serves as the negative electrode collector 31N

The components in the composite paste 37 and the insulation paste 61 including the electrode active material, the insulative material, and the binding material may be changed.

In the above embodiment, the stack of the positive and negative electrode sheets 35P and 35N is rolled with the separator 5 held in between to form the electrode body 10. The structure described above may also be applied to an electrode body 10 including a stack of electrode plate groups. The rechargeable battery 1 to which the electrode body 10 is applied does not necessarily have to be a lithium-ion battery and may be another type of a non-aqueous electrolyte rechargeable battery. The structure described above may also be a rechargeable battery other than a non-aqueous electrolyte rechargeable battery.

The shapes of the positive electrode terminal 38P and the negative electrode terminal 38N are not limited to the shapes illustrated in FIG. 1 and may be changed in any manner.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electrode body, comprising:
a substrate serving as a collector;
a composite layer formed by applying a composite paste including an electrode active material to the substrate;
an insulation layer formed by applying an insulation paste including an insulative material to the substrate adjacent to the composite layer, wherein the composite layer extends above and overlaps the insulation layer that covers a surface of the substrate in an interface region of the composite layer and the insulation layer; and
a mixed layer formed between the insulation layer and the composite layer when the composite paste and the insulation paste mix in an overlapping range of the insulation layer and the composite layer,
wherein the mixed layer is formed in a range where the insulation layer covers the surface of the substrate.

2. The electrode body according to claim 1, wherein the mixed layer is formed between the insulation layer and a distal end portion of the composite layer extending into the interface region.

3. The electrode body according to claim 1, wherein the mixed layer extends to a position above the insulation layer where the composite layer does not exist.

4. The body electrode according to claim 1, wherein:
the composite layer extending in the interface region includes a composite slope having a thickness that gradually decreases toward an end of the substrate where the insulation layer is applied;
the insulation layer covers the surface of the substrate in a range where the composite slope portion is formed; and
the insulation layer does not extend beyond a range where the composite slope is formed into an area below the composite layer.

5. The electrode body according to claim 1, wherein the insulation layer has a higher binder component content ratio than the composite layer.

6. The electrode body according to claim 1, wherein the composite layer is a positive electrode active material layer.

7. A rechargeable battery, comprising:
the body electrode according to claim 1.

8. A method for manufacturing an electrode including a substrate serving as a collector, a composite layer formed by applying a composite paste including an electrode active material to the substrate, and an insulation layer formed by applying an insulation paste including an insulative material to the substrate adjacent to the composite layer, the method comprising:
simultaneously applying, to the substrate, the composite paste and the insulation paste that are adjusted so that a mixed layer is formed between the insulation layer and the composite layer by mixing the composite paste and the insulation paste in an overlapping range of the insulation layer and the composition layer where the composition layer overlaps an upper side of the insulation layer that covers a surface of the substrate in an interface region of the composite layer and the insulation layer and so that the mixed layer is formed in a range where the insulation layer covers the surface of the substrate.

9. The method according to claim 8, wherein the insulation paste has a higher flowability than the composite paste when applied to the substrate.

10. The method according to claim 8, wherein the insulation paste has a lower viscosity in a low shear rate region than the composite paste.

11. The method according to claim 8, wherein the insulative material included in the insulation paste has a smaller particle diameter than the electrode active material included in the composite paste.

12. The method according to claim 8, wherein the composite paste applied per unit area to the substrate is greater in amount than the insulation paste.

13. The method according to claim 8, wherein the insulation layer has a higher binder content ratio than the composite paste.
